(19) United States
(12) Patent Application Publication
(10) Pub. No.: US 2005/0015338 A1
(43) Pub. Date: Jan. 20, 2005

(54) Electronic Statement Organizer with User Interface and Integrated Bill Payment

(76) Inventor: Lawrence Weekhar Lee, Menlo Park, CA (US)

Correspondence Address: LAWRENCE W. LEE, 1968 MENALTO AVENUE, MENLO PARK, CA, 94025, US

(21) Appl. No.: 10/710,495

(22) Filed: Jul. 15, 2004

Related U.S. Application Data
(60) Provisional application No. 60/487,652, filed on Jul. 16, 2003.

(51) Int. Cl. G06F 17/60

(52) U.S. Cl. 705/40

(57) ABSTRACT

A software product, computer implemented method, and system that enable individuals to access, download, organize, store, and retrieve electronic statements and other account notices with a computer via a communication network. The stored statements are organized by their corresponding accounts and cataloged in a storage system enabling the user to search, retrieve, and manage statements and account information. This, in turn, simplifies downloading of account information, organization of that information, subsequent retrieval of such information and integration of such information into other financial management applications and bill payment applications. The system embodiments include a plurality of interfaces, storage systems, and integration of personal or business financial management software and bill payment systems.

### CROSS REFERENCE TO RELATED APPLICATIONS

This application claims priority under 35 U.S.C. §119(e) to U.S. Provisional Patent Application No. 60/487,652, filed Jul. 16, 2003, by Lawrence W. Lee, entitled “Electronic Statement Organizer with Integrated Bill Payment and User Interface,” which application is incorporated by reference herein.

### BACKGROUND OF INVENTION

In recent years, with the improvements in personal computers and the wide-spread increase in the popularity of the Internet and wireless technologies such as 802.11 (also known as WiFi), more and more individuals have begun using personal computers to access and manage their financial records over the Internet. Today, many financial institutions such as banks and stock brokerages, as well as businesses such as telephone companies and utilities, offer their customers online access of their financial statements, bills, and account notices.

The use of the Internet to deliver digital or electronic statements has enabled individuals to more efficiently manage their finances, which, naturally, leads to more efficient utilization of personal resources. For example, individuals can now obtain timely information about their financial transactions, account balances, and billing information by connecting to the companies and their accounts via the Internet. By monitoring monthly transactions in their accounts, individuals are now, more than ever, capable of managing their finances. With electronic statement, individuals are able to organize, search for, and find specific transaction easier and more efficiently. Moreover, individuals using electronic statements are freed from the hassle of receiving paper statements in the mail, opening and storing the papers, as well as having to manually search through piles of paper when looking for a particular record in the accounts. These and other benefits of using electronic statements have yielded a virtual revolution in the ability of individuals in managing their personal or business finances.

The use of the Internet to deliver electronic statements also allows institutions and businesses to eliminate the substantial costs of delivering paper statement by mail, such as the cost of paper, printing, storage, and mailing, as well as reduce the costs associated with late or lost statements. Furthermore, institutions and businesses are able to provide electronic statement that conforms to the visual format or “look-and-feel” of their paper statement, providing branding, familiarity, and authenticity for the statement. By providing electronic statements, businesses are able to serve their customer better, in a timelier manner, and more efficiently.

For a variety of reasons, however, electronic statement has not realized the level of wide-spread acceptance by individuals that is expected. A number of deficiencies associated with the lower than expected level of acceptance of electronic statement arise from the fact that there is no convenient way for individuals to retrieve, organize and store electronic statements provided by multiple financial institutions and businesses. Financial institutions and businesses often provide their electronic statements, sometimes in their unique data formats, through various account login processes that are different from one another. As a consequence, individuals have to log in to each business and/or account separately to retrieve electronic statements from each business and/or account. Moreover, there is no convenient way to organize these electronic statements once they are retrieved; and as with paper statements, they may be easily misplaced, accidentally deleted, or lost in the folders and files.

To help individuals better manage their finances, many software packages for use on personal computers such as Quicken (manufactured by Intuit, Inc.) and Money (manufactured by Microsoft Corporation) allow users to download their statements, track their investments and loans, bank and pay bills online, monitor expenditures, create detailed financial reports, and even prepare tax returns. However, these software packages generally do not retrieve or store, not to mention organize, electronic statements with the visual format or “look-and-feel” of paper statements provided by the issuing institutions or businesses. These software packages generally convert the statement information provided by the institutions or businesses into their own data formats (such as QIF for Quicken) for storage and manipulation.

Therefore, there remains a need in the art for alternative systems, methods and related software products to enable individuals to easily retrieve, organize, store and make use of electronic statements, bills, and account notices in the visual format provided by their financial institutions and businesses.

There remains an additional need in the art for alternative systems, methods and related software products which are capable of (1) integrating electronic statements in visual format with online bill payment; and (2) permitting individuals to subsequently retrieve the information contained in the electronic statements so that it can be integrated into other personal or business financial management software.

There remains yet another need in the art for alternative systems, methods and related software products of the type described above which offer users an optimal combination of simplicity, reliability, efficiency and versatility.

### SUMMARY OF INVENTION

The present invention satisfies the above needs, and overcomes the above-stated and other deficiencies of the prior art, by providing systems, methods and related software products that enable individuals to retrieve electronic statements, bills, and other account notices with the visual format or “look-and-feel” of paper statements provided by the issuing institutions or businesses in a simple, convenient, timely, and cost effective manner. Generally, the present invention makes these and other benefits possible by providing a software system that enables individuals to easily access their electronic statements, organize and store the electronic statements, retrieve the electronic statements, and use the information provided by the electronic statements. The present invention also enables individuals to easily integrate their electronic statements with bill payment systems and with other personal and business financial management software.

These benefits to individuals, in turn, enable the issuing institutions and businesses to promote acceptance of electronic statements by their customers to realize substantial operational costs saving associated with the regulatory required delivery of statements, bills, and account notices. Furthermore, the present invention allows the issuing institutions and businesses to retain the unique visual format or “look-and-feel” of their statements, bills, and account notices so they can continue to reinforce their branding and relationship with their customers.

The present invention capitalizes on the widespread popularity of the Internet, familiarity of individuals with traditional paper financial statements and filing systems, increase in the use of electronic statements, convenience of the personal computer, and decreasing cost of electronic storage devices and systems. The system embodiments of the present invention generally comprise of a software system with user interface, one or more electronic storage devices or systems, integration with other software or data systems, and network communication functionality.

In one embodiment of the present invention, there is provided an electronic statement management software system having as its primary user interface a single display screen for presentation on a display device of a personal computer. The user interface includes a user selectable menu that integrates the tasks of account access via a communication network such as the Internet, accounts management, downloading of electronic statements, viewing statements, organizing and storing statements, retrieving statements, finding statements, listing of accounts and statements, and bill payment. The user interface employs a file folder metaphor for organization and storage of electronic statements. The electronic statements may be downloaded or scanned, and stored in a plurality of data formats such as JPEG, BMP, TIFF, PCT, PDF, MHT, HTML, and XML/XSL. The downloaded electronic statements may be stored on a plurality of devices communicatively linked via a communication network. The particular manner in which the software accesses, downloads, organizes, and stores the electronic statements is defined by the number and nature of accounts which are preferably supplied by the individuals and the issuing institutions or businesses. The software system may employ XML to extract relevant information from the statements. The software system may also employ a character recognition algorithm for conversion of pictorial images of electronic statements into alphanumeric data for ease of integration with other personal or business financial management software as well as with bill payment applications or systems.

In another embodiment of the present invention, there is provided a software component designed to plug into an Internet browser such as Microsoft Internet Explorer, Netscape Navigator, and Mozilla, to enable user selectable drop down menu to perform electronic statement management functions. A description of such embodiment is contained in the product specification entitled “eStatement Manager, version 0.35” which is incorporated by reference herein.

In yet another embodiment of the present invention there is provided a server software and Internet-based service that enable individuals to access, retrieve, organize, store, and manage electronic statements on remote storage device(s) accessible via a communication network.

The present invention may be implemented using a plurality of computer languages such as C, C++, Java, C#, PERL, HTML, and XML, and may support a plurality of operating systems such as Microsoft Windows, Apple OS, Linux, and Unix with software development frameworks such as web services, Microsoft.NET, and SUN One, running on a plurality of hardware platforms such as personal computer, handheld computer, convergence device, work-station, and applications server.

### BRIEF DESCRIPTION OF DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram illustrating the relationships of the present invention with other nodes in the communication network.

FIG. 2 is an illustration of the screen display of an exemplary embodiment of the present invention.

FIG. 3A shows the sub menu items under the “Start Here” menu item.

FIG. 3B shows the sub menu items under the “Account” menu item.

FIG. 4 shows the sub menu items under the “Statement” menu item.

FIG. 5 shows the “Import Statement” sub menu item under the “Statement” menu item.

FIG. 6 is an illustration of the screen display of an exemplary embodiment of the present invention within an Internet browser.

### DETAILED DESCRIPTION

The present invention involves a system and method for managing electronic documents such as electronic account statements, electronic bills, electronic notices, and electronic brochures in a computing device such as a general purpose computer, laptop computer, or handheld computer and communicating with the providers of electronic documents via a communication network.

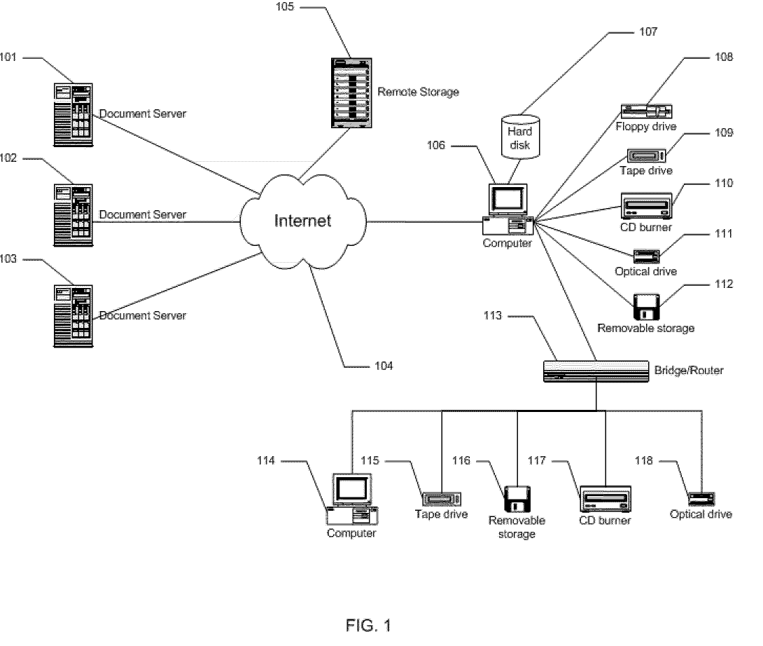

In the preferred embodiment, the present invention resides in computer 106 illustrated in FIG. 1 and communicates with a plurality of document servers, such as document server 101, 102, and 103, via a communication network such as the Internet 104. The present invention initiates communication with the document servers, retrieves electronic documents from the document servers, and stores the electronic documents on a plurality of storage devices such as local hard disk 107; or remote storage 105 connected to computer 106 via a communication network such as the Internet 104; or storage devices connected to computer 106 via bridge/router 113 such as another computer 114, tape drive 115, removable storage 116, cd burner 117, and optical drive 118; or storage devices directly connected to computer 106 such as floppy drive 108, tape drive 109, CD burner 110, optical drive 111, and removable storage 112. The present invention can be implemented in software, using standard programming languages, methods and techniques which are well known in the art.

In another embodiment, the present invention resides on an application server accessible by the individuals via a communication network such as the Internet.

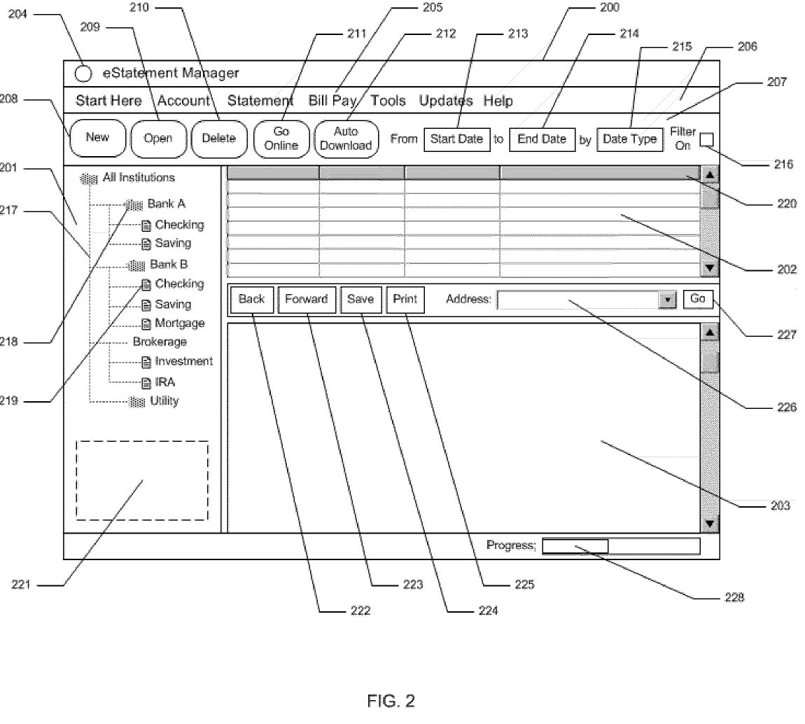

An exemplary embodiment of the present invention employs a number of core features as illustrated in FIG. 2. In an exemplary embodiment, the present invention employs a user interface 200 with three distinguished display areas 201, 202, and 203. Display area 201 displays a listing 217 of the user's entity 218 and account 219. Display area 202 displays general information or notices, either in text or graphic format, when the present invention is first executed; and displays a listing of documents associated with the entities or accounts when the user selects an entity 218 or account 219 in the first display area. Display area 203 displays an Internet browser when no document is selected in the second display area; and displays the actual document when a document is selected in the second display area.

When display area 202 displays a listing of documents, the list can be sorted by entity, account, title, start date, end date, or due date by selecting one of the fields in the field bar 220.

The present invention employs a logo 204 for identification and marketing purposes. Logo 204 is customizable.

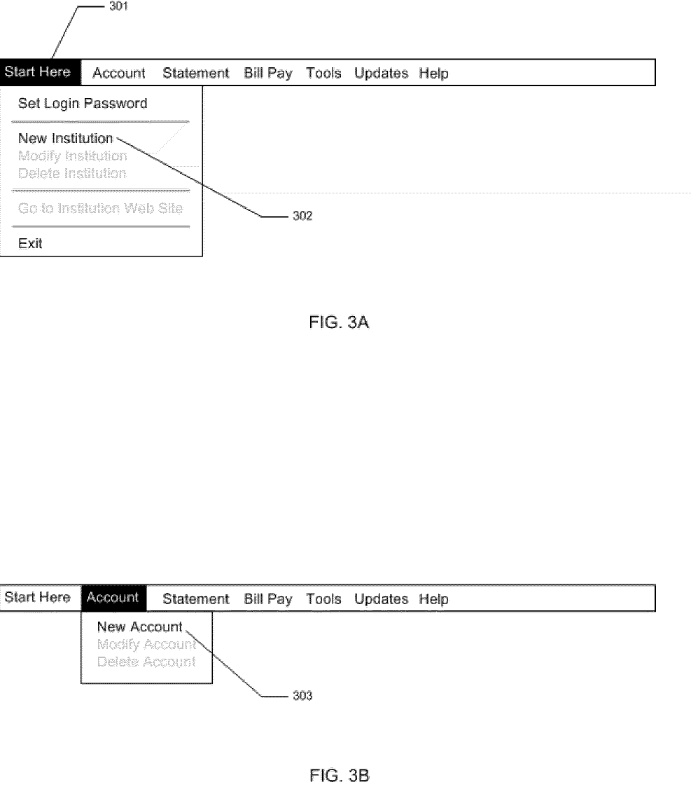

The user creates a new entity 218 by selecting “New” button 208 on toolbar 207 while having the “All Institutions” category on listing 217 selected. Alternatively, the user may create a new entity 218 by selecting menu item “Start Here” 301 in menu bar 206 followed by “New Institution” 302 as illustrated in FIG. 3A, while having the “All Institutions” category on listing 217 selected. The user will be prompted to enter information regarding the entity, such as the name of the entity, Universal Resource Locator (URL) of the entity's web site, and user identification and password where appropriate. Upon entering the entity information, an entity 218 will be created on listing 217.

To create a new account 219, the user may select “New” button 208 on toolbar 207 while having the entity 218 of which the account 219 belongs to selected. Alternatively, the user may select menu item “Account” in menu bar 206 followed by “New Account” 303 as shown in FIG. 3B while having the entity 218 of which the account 219 belongs to selected. The user will be prompted to enter information for the account, such as account name. Upon entering the account information, an account 219 will be created on listing 217 under the selected entity.

To modify the information for an entity, an account, or a statement, the user can select the desired entity, account, or statement in display area 201 and 202 followed by “Open” button 209. The user can then change the entity or account information presented in a display area. Alternatively, the user can modify the information for an entity, an account, or a statement by selecting the entity, account, or statement followed by the appropriate menu item in menu bar 206.

To delete an entity, an account, or a statement, the user can select the desired entity, account, or statement followed by “Delete” button 210. The user will be prompted to confirm the deletion. Upon confirmation, the selected entity, account, or statement will be deleted from the data storage as well as removed from the listings. Alternatively, the use can delete an entity, an account or a statement by selecting the entity, account, or statement followed by the appropriate menu item in menu 206.

The user can access an entity's web site by selecting the entity 218 in display area 201 then selecting “Go Online” button 211 on tool bar 207. Alternatively, the user can type the entity's URL directly into Address Field 226 and select the “Go” button 227 or press the Enter key on the keyboard. Upon executing the above steps, display area 203 will display the desired entity's web site. The user can then navigate within the web site to access the desired electronic document as well as navigate to a previously viewed web site by selecting “Back” button 222 and “Forward” button 223. The Progress Bar 228 shows the progress of communication between the present invention and the web site server.

To store the electronic document accessed, the user will request a printable or printer-friendly version of the electronic document such as those formatted in PDF, mht, or XML/XSL format. Once the printable or printer-friendly document is displayed, the user can select the account 219 in which the document is to be associated with in listing 217, followed by selecting “Save” button 224 to store a copy of the document in a storage device and location designated by the user. The present invention will prompt the user for information pertaining to the document, such as name for storing the document and associated date ranges. The present invention will then download and store a copy of the electronic document in the user designated storage device and create a new item on document listing in display area 202.

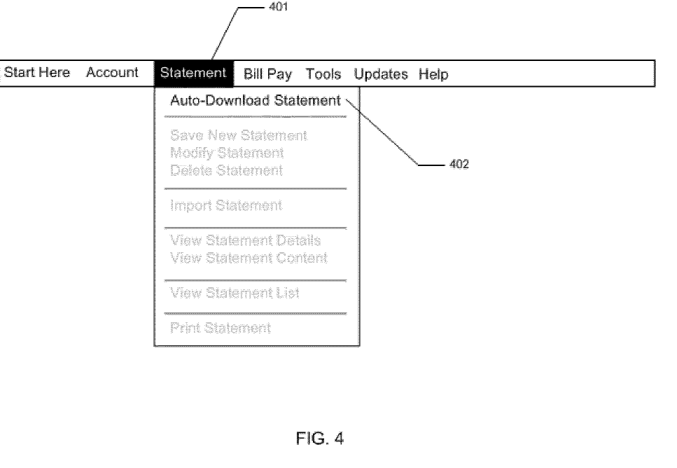

In an exemplary embodiment of the present invention, the user can automatically access, download, and store available electronic documents from an entity that has provided direct access to the present invention, by selecting the entity 218 in listing 217 followed by selecting the “Auto Download” button 212, or by selecting “Statement” 401 on menu bar 206 and then selecting the item labeled “Auto-Download Statement” 402 as illustrated in FIG. 4. The present invention will establish communication with the entity, verify available documents in all accounts associated with the entity, and download and store documents that have not been previously downloaded to the user designated storage device and location.

In an exemplary embodiment of the present invention, the user can modify the information pertaining to the document via a display area for information modification. The user can also change the association of a document with an account and the association of an account with an entity via a display area for association modification. In another embodiment of the present invention, the user can change the document and account associations by drag-and-drop of the document or account from an account 219 or entity 218 to another account 219 or entity 218.

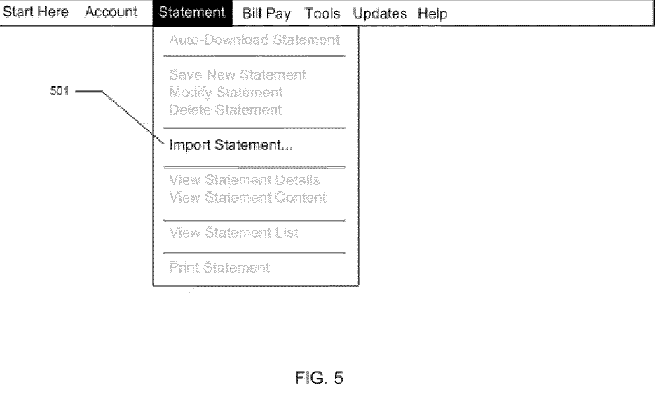

The user can import electronic documents that have previously been stored without using the present invention into the present invention by selecting “Statement” 401 on menu bar 206 followed by “Import Statement . . . ” 501 as illustrated in FIG. 5. The user will be prompted for information of the document to be imported, such as name of the document, location of the document, and account to be associated with. Upon entering the information, a copy of the document will be retrieved and stored by the present invention for later access and viewing.

To display a previously stored document, the user can select the desired document in display area 202. Upon selection, the document will be displayed in display area 203. The user can view the entire list of previously stored documents, or by entity or account to which the documents are associated, by selection “All Institution”, an entity, or an account, respectively in display area 201. The user can filter the list of documents by specifying “Start Date” 213, “End Date” 214, and “Date Type” 215, and select filter checkbox 216. The use can also print the document that is displayed in display area 203 by selecting “Print” button 225.

In an exemplary embodiment of the present invention, the user can initiate a transaction such as bill payment relating to an electronic document by selecting the desired document followed by selecting menu item “Bill Pay” 205. The present invention will prompt the user for confirmation of the transaction information such as transaction amount, method of transaction, and transaction parties. Upon receiving the confirmation information, the present invention will send instructions to a user designated transaction processing entity to carry out the transaction, and record the transaction. The present invention can also display a collection of electronic bills that require payment in one place and allows the user to make payment on multiple bills by selecting the desired bills followed by selecting “Bill Pay” 205 to initiate the transactions. The ability of the present invention to display a collection of bills in one place offers considerable convenience to the user.

In the preferred embodiment of the present invention, in addition to displaying the list of entities 218 and accounts 219, a region 221 of display area 201 can be employed to display information, such as announcements, notices, or advertisements, for the user's consumption. The information may be displayed in text, graphical format, or combination of both. The region 221 may also include URL links to web sites that when selected will be displayed in display area 203.

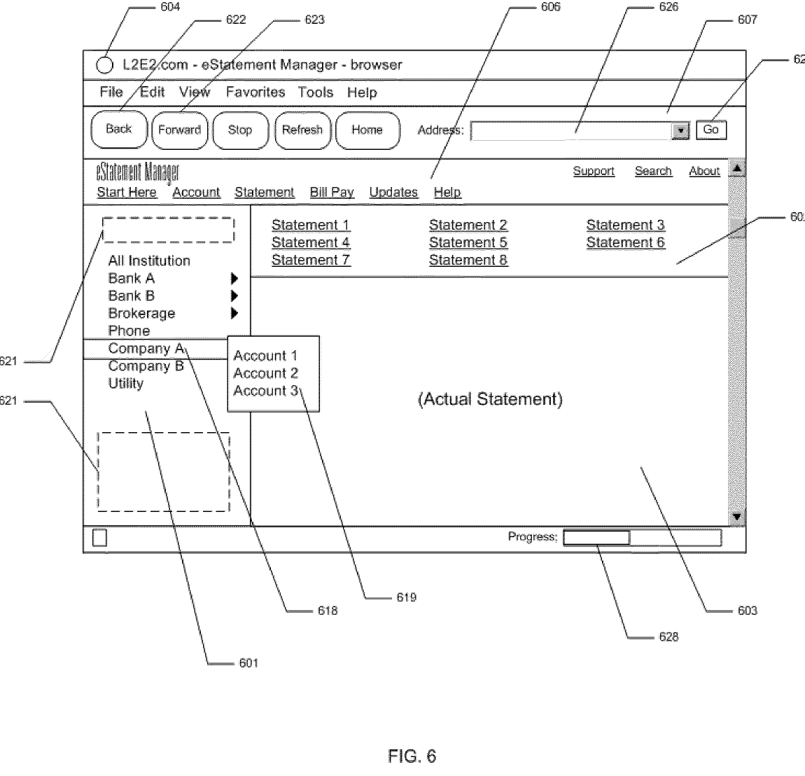

In another embodiment of the present invention, the above mentioned functionality can be implemented within an Internet browser, such as Internet Explorer, Netscape, and Mozilla. The screen display and user interface of an exemplary embodiment of the present invention within an Internet browser is illustrated in FIG. 6. For example, display areas 601, 602, and 603 perform similar functions as dispay areas 201, 202, and 203 respectively; menu bar 606 performs similar functions as menu bar 206; and buttons 622 and 623 perform similar functions as buttons 222 and 223 respectively, and so forth.

1. A computer program executable by a processor, for producing a user interface for accessing, downloading, importing, displaying, and storing electronic documents in the visual format provided by the issuing entities using a communication network, and organizing, archiving, retrieving, and displaying electronic documents stored on electronic storage devices specified by the user in the visual format provided by the issuing entities, the user interface comprising:
a first display area for displaying a listing of the entities where the user maintains one or more accounts and listing of such accounts;
a second display area, visually distinguished from the first display area, for displaying general information or notices when the program is first executed; and displaying a listing of documents associated with the entities or accounts when the user selects an entity or account in the first display area; and
a third display area, visually distinguished from the first and second display areas, for displaying a web page when no document is selected in the second display area; and displaying the actual document when a document is selected in the second display area.

2. The program of claim 1, wherein the third display area is used for browsing the Internet generally.

3. The program of claim 1, wherein each of the display areas is individually resizable by the user.

4. The program of claim 1, wherein the user interface is comprised of additional display areas for displaying additional information on the user selected entity, account, or document.

5. The program of claim 1, wherein additional display areas are used to request and receive information and instructions from the user.

6. The program of claim 1, wherein a portion of the display areas is used to display additional information or hypertext links.

7. A computer implemented method for accessing, downloading, importing, displaying, and storing electronic documents in the visual format provided by the issuing entities using a communication network, and organizing, archiving, retrieving, and displaying electronic documents stored on electronic storage devices specified by the user in the visual format provided by the issuing entities, comprising:
storing a list of the entities where the user maintains one or more accounts and a list of such accounts;
storing the user information required for access to the accounts;
sending instruction via a communication network to the entity for access to electronic documents;
downloading the electronic documents that have not been previously downloaded in the visual format provided by the issuing entities;
storing the downloaded electronic documents in the visual format provided by the issuing entities to the user specified electronic storage device;
storing a list of the downloaded electronic documents associated with each of the user's accounts;
retrieving electronic documents matching the criteria specified by the user; and
displaying the retrieved electronic documents in the visual format provided by the issuing entities.

8. The method of claim 7, further comprising:
automatically sending instructions to user specified entities and accounts to check for electronic documents that have not been downloaded previously to the user specified electronic storage device; and
automatic downloading of these documents.

9. The method of claim 7, further comprising:
downloading and storing electronic documents in non-visual formats provided by the issuing entities; and
retrieving and displaying electronic documents in non-visual formats provided by the issuing entities;

10. The method of claim 7, further comprising optical character recognition of the information contained within the stored documents.

11. The method of claim 7, further comprising scanning of paper documents into electronic formats for storage, retrieval, and display on electronic devices.

12. The method of claim 7, further comprising:
receiving search criteria from the user via a user interface;
searching for specific information contained within the stored electronic documents based on the criteria provided by the user;
retrieving the electronic documents containing the specific information that matches the user's criteria; and
displaying the electronic documents containing the specific information that matches the user's criteria.

13. The method of claim 9, further comprising:
accessing, downloading, importing, exporting, and storing electronic documents in non-visual formats; and
organizing, archiving, and retrieving electronic documents in non-visual formats.

14. The method of claim 9, further comprising:
associating the electronic documents in visual format with their corresponding non-visual format electronic documents.

15. The method of claim 7, further comprising:
collecting electronic documents that require transaction processing;
receiving instructions for processing transactions relating to the electronic documents, the specific amounts to process, the dates to process, and authorization information from the user;
sending instructions to a transaction processing entity for transaction processing;
receiving transaction processing confirmation information from the transaction processing entities; and
storing transaction processing records and confirmation information.
